(19) United States
(12) Patent Application Publication
(10) Pub. No.: US 2007/0049259 A1
(43) Pub. Date: Mar. 1, 2007

(54) Portable communication terminal, evacuation route display system, and emergency alert broadcasting device

(75) Inventors: Masashi Onishi, Yokohama-shi (JP); Takashi Sasaki, Yokohama-shi (JP); Tetsuya Nakanishi, Yokohama-shi (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/501,243

(22) Filed: Aug. 9, 2006

(30) Foreign Application Priority Data
Aug. 25, 2005 (JP) 2005-244136

(51) Int. Cl. H04Q 7/22

(52) U.S. Cl. 455/414.2

(57) ABSTRACT

A portable communication terminal and a evacuation route display system are arranged to guide a user to a safe area in emergency situation, and a emergency alert broadcasting device is arranged to detect smoke or noxious gas and to broadcast the detected information to a plurality of portable communication terminals. The portable communication terminal includes a receiving section that receives emergency information and a display section that displays the emergency information. The evacuation route display system includes a base station including a memory that stores map information and evacuation route information and a circuit that transmits the map information and the evacuation route information to the terminal during emergency. The emergency alert broadcasting device includes a detecting device that detects smoke or noxious gas, and an information-sending unit that sends the detected information and evacuation information over a communication network to portable communication terminals.

### CROSS-REFERENCE TO RELATED APPLICATIONS

This application claims priority to Japanese Patent Application No. 2005-244136 filed on Aug. 25, 2005. The entire disclosure of Japanese Patent Application No. 2005-244136 is hereby incorporated herein by reference.

### BACKGROUND OF THE INVENTION

1. Field of the Invention

The present invention relates to a portable communication terminal and an evacuation route display system using the terminal which is configured and arranged to obtain emergency information in emergency situations such as earthquakes and the like and to guide a person possessing the terminal to a safe area. The present invention also relates to an emergency alert broadcasting device configured and arranged to detect smoke and noxious gas generated in a target area and to broadcast this information to a plurality of portable communication terminals.

2. Description of the Background Arts

Japanese Patent Application Laid-Open No. 9-62964 discloses a fire perception sensor that observes a target area by an infrared camera, obtains a temperature distribution image, detects differences in the sequence of the temperature distribution image, and determines that a fire has occurred when there is a difference.

Japanese Patent Application Laid-Open No. 2000-233029 discloses a fire evacuation guide system that detects smoke during a fire and ensures an evacuation route. In this system, the generation of smoke is monitored by a smoke detecting section disposed at a plurality of locations within a structure such as a building. When the smoke detecting section has detected smoke, an image processing section determines the flow behavior of the smoke based on the detection information. Based on the origin position of the smoke and the dispersion direction of the smoke flow as determined by the image processing means, an evacuation guide display displays an evacuation guide direction that is distanced from the smoke dispersion direction within the building.

In recent years, facilities such as airports, theaters, subway stations and the like have come under increasing danger from terrorist chemical attacks (noxious gas dispersion) and terrorist bombing attacks. In such facilities, terrorist attacks are thwarted by installing security means such as inspecting hand-carried bags and the like.

However, the fire perception sensor disclosed in Japanese Patent Application Laid-Open No. 9-62964 does not provide evacuation route information and is limited to automatically detecting fire. Thus, there is concern that panic may ensue among the crowds of people within such facilities as, for example, airports, theaters, and subway stations when sirens wail as a result of the fire perception sensor detecting a fire in the facilities. In order to avoid causing panic, the facilities employees may forgo the siren warning and guide people to an evacuation route according to a procedure determined beforehand by announcing the fire to everyone in the facility. In this case, there is concern that erroneous evacuation procedure could cause a major disaster.

The fire evacuation guide system disclosed in Japanese Patent Application Laid-Open No. 2000-233029 can not function when the smoke obscures the evacuation route guide display, or when the communication lines are cut and the system (control computer) is down during a major earthquake or the like.

Furthermore, despite some measures are taken to thwart a terrorist attack in these facilities, prompt and adequate response may not be taken when noxious gas be dispersed, or when a bomb is discovered or exploded. For example, since dispersion of noxious gas only becomes known after casualties are caused, people near the victims of the noxious gas may be thrown into a panic. Moreover, even when a call for evacuation has been announced, it may be difficult to determine in which direction to evacuate.

When, for example, a chemical agent has been dispersed at several locations within the same facility simultaneously, it may be difficult to indicate an evacuation route to many people spread over a wide area. Furthermore, suitable emergency treatment may be needed for various kinds of dispersed noxious gases. In such case, there is concern that appropriate emergency measures may not be rapidly implemented, because identification of the type of chemical by experts may require a lot of time. Similar circumstances may arise when a bomb is discovered or exploded, inasmuch as it could prove difficult to specify an evacuation route quickly to many people. Moreover, it may not be easy to provide appropriate emergency treatment to bomb-injured victims.

### SUMMARY OF THE INVENTION

An object of the present invention is to provide a portable communication terminal and evacuation route display system using the terminal that are configured and arranged to obtain alarm information in emergency situation and rapidly guiding the person carrying the terminal to a safe area. Another object of the present invention is to provide an emergency alert broadcasting device that detects smoke or noxious gas in a target area and, in some cases detects the type of noxious gas, and broadcasts the information to a plurality of portable communication terminals.

These objects are attained by providing a portable communication terminal including a receiving section configured and arranged to receive disaster information, and a display section configured and arranged to display the disaster information.

According to another aspect of the present invention, an evacuation route display system is provided that includes a base station having a memory configured and arranged to store map information that includes safe area information and/or evacuation route information that includes evacuation routes to the safe areas, and a broadcast transmitting circuit configured and arranged to send the map information and/or evacuation route information to the portable communication terminal of the present invention when a disaster occurs.

According to yet another aspect of the present invention, an emergency alert broadcasting device is provided that includes a detecting device configured and arranged to detect smoke or noxious gas generated in a target area, and an information sending unit configured and arranged to send location information of the smoke or noxious gas and/or evacuation information over a communication network to a plurality of portable communication terminals when the detecting device has detected smoke or noxious gas.

### BRIEF DESCRIPTION OF THE DRAWINGS

Referring now to the attached drawings which form a part of this original disclosure:

FIG. 1 is a schematic view illustrating an evacuation route display system according to one embodiment of the present invention, the display system including a base station;

FIG. 2A is a schematic diagram of the base station of the evacuation route display system according to the one embodiment of the present invention;

FIG. 2B is a simplified schematic view of an example of a map image displayed in the portable communication terminal according to one embodiment of the present invention;

FIG. 3 is a block diagram of a control system in the portable communication terminal;

FIG. 4A is a perspective view of the portable communication terminal;

FIG. 4B is a simplified schematic view of a map image displayed in the terminal oriented in the direction shown in FIG. 4A;

FIG. 5A is a perspective view of the terminal oriented in a different direction than that of FIG. 4A;

FIG. 5B is a simplified schematic view of a map image displayed in the terminal oriented in the direction shown in FIG. 5A;

FIG. 6 is a schematic diagram showing an example of a emergency broadcasting system that includes an emergency alert broadcasting device according to one embodiment of the present invention;

FIG. 7 is a schematic diagram of the emergency alert broadcasting device according to the one embodiment of the present invention;

FIG. 8 is a schematic diagram of a base station used in the emergency broadcasting system illustrated in FIG. 6; and

FIG. 9 is a schematic diagram showing an example of a emergency broadcasting system including an emergency alert broadcasting device according to an alternative embodiment of the present invention.

### DETAILED DESCRIPTION OF THE INVENTION

These and other features, aspects, and advantages of the present invention will be better understood through the following description, appended claims, and accompanying drawings. In the explanation of the drawings, an identical mark is applied to identical elements and an overlapping explanation will be omitted.

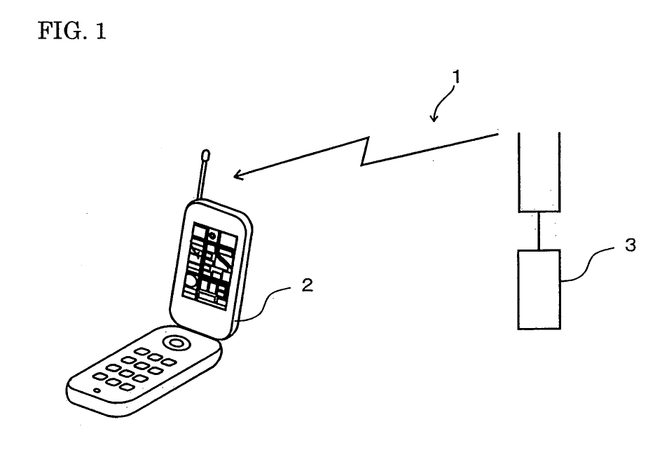

FIG. 1 is a schematic view illustrating an evacuation route display system 1 according to one embodiment of the present invention. The display system 1 includes a base station 3 to transmit emergency information to a portable communication terminal 2 of the present invention. In the present embodiment, the terminal 2 is a portable telephone.

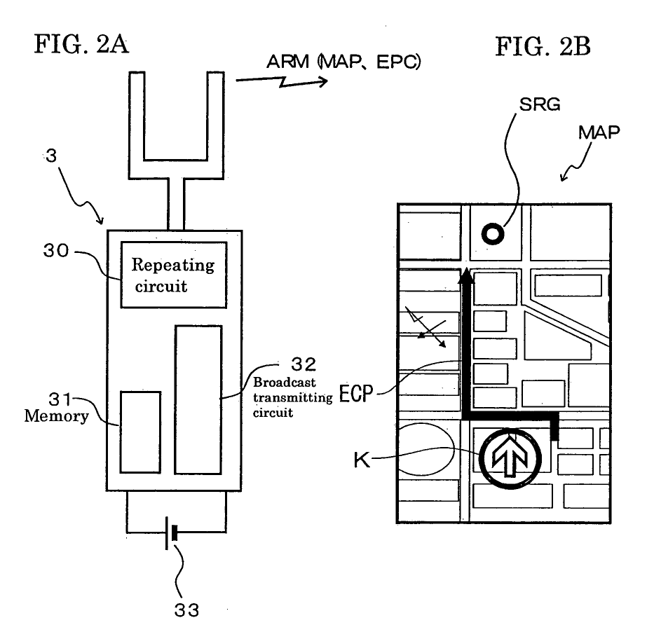

FIG. 2A is a schematic diagram of the base station 3 in the display system 1. The base station 3 is provided with a memory 31 and a broadcast transmitting circuit 32 in addition to a repeating circuit 30 which is similar to a repeating circuit in the base station of the conventional portable telephone network.

The memory 31 may be a complementary metal oxide semiconductor or other nonvolatile memory that stores the map information MAP including information of safe areas SRG (evacuation centers) and evacuation route information ECP. The broadcast transmitting circuit 32 performs broadcast transmission of alarm information ALM including the map information MAP and evacuation route information ECP during a disaster. The broadcast transmitting circuit 32 may perform only transmission, and in which case, a reception function need not be provided. Part of the repeating circuit 30 may be used as the memory 31 and broadcast transmitting circuit 32. Broadcast transmission may be accomplished at a common frequency for all carriers, or performed at a discrete frequency for each carrier. The base station 3 may be provided with a backup battery 33, in which case the alarm information ALM can be sent to the terminals 2 during a power stoppage.

FIG. 2B shows an example of a map image displayed on the terminal 2 of the present invention. The map information MAP is displayed on a display section of the terminal 2 as a map image. Over the map image, the safe area SRG and evacuation route information ECP which is indicated with a black arrow can be displayed and information indicating the optimum escape direction can be highlighted in the display as indicated with the reverse-white arrow K. The map information MAP may be automatically updated with updated information by portable phone carrier, or may be updated by the user of the terminal 2 at any time. The evacuation route information ECP may be a single type of information, but is not necessarily limited to a single type of information since traffic conditions may differ, for example, during daytime and nighttime. A clock function not shown in the drawing is provided in the base station 3 when the evacuation route information ECP is distinguished between day and night.

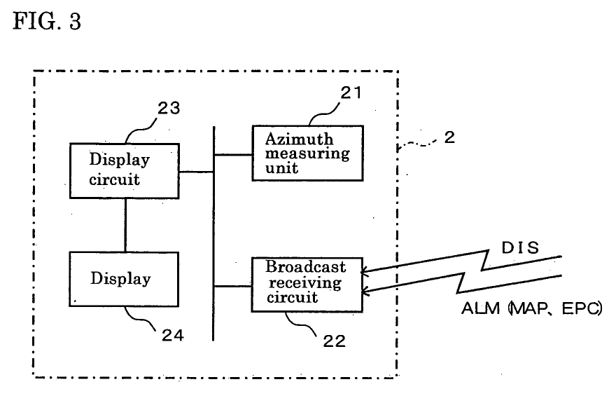

FIG. 3 is a block diagram illustrating a system of the terminal 2. The terminal 2 includes an azimuth measuring unit 21, a broadcast receiving circuit 22 (receiving section), a display circuit 23, and a display section 24 in order to obtain disaster information DIS and display information for guiding the user to a safe area SRG during a disaster.

The azimuth-measuring unit 21 is typically a magnetic azimuth compass. If the terminal 2 is provided with a built in GPS terminal function, the azimuth-measuring unit 21 can be configured and arranged to utilize the azimuth compass function of the GPS. The azimuth-measuring unit 21 is configured and arranged to generate azimuth information DRC. The broadcast receiving circuit 22 is configured and arranged to receive broadcasts of the alarm information ALM from the base station 3.

The alarm information ALM may also be received from another terminal 2 that has already obtained the alarm information ALM if the terminals 2 are conformed to ad hoc wireless communication. Generally, the ad hoc wireless communication distance is relatively short at approximately 50 to 100 m. Therefore, by limiting the number of links, for example, by preventing subsequent transfers at a time when alarm information has been transferred from terminal A to terminal B and terminal B to terminal C, problems can be avoided in which one's location may not be included in a map that is included in the map information MAP received from another portable communication terminal or the evacuation route information ECP may differ from the actual evacuation route.

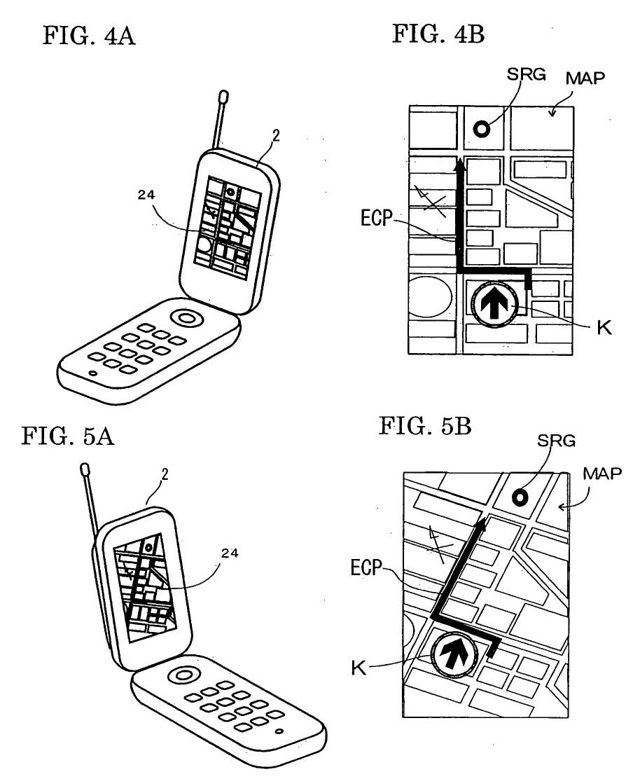

The display circuit 23 processes the azimuth information DRC and the alarm information ALM to display the map included in the map information MAP and the evacuation route included in the evacuation route information ECP on the display section 24 with the actual azimuth. FIG. 4A is a perspective view of the terminal 2, and FIG. 4B shows a map image displayed in the terminal 2 oriented in the direction shown in FIG. 4A. FIG. 5A is a perspective view of the terminal 2 placed in the same location as in the location of the terminal 2 illustrated in FIG. 4A but oriented in a different direction than terminal 2 illustrated in FIG. 4A. FIG. 5B shows the map image displayed in the terminal 2 oriented in the direction shown in FIG. 5A. Although the direction of the terminal 2 is different in FIGS. 4A and 5A, the evacuation route information ECP and the mark K indicating the direction of escape matches the actual direction on the display section 24.

The base station 3 can send an automatic activation request signal ASR to the terminal 2 prior to a broadcast, and the terminal 2 that has received the automatic activation request signal ASR is automatically activated. In this case, the terminal 2 must be provided with a function which automatically activates the terminal with the activation request signal ASR. When a disaster occurs, the terminal 2 may be unable to take a call via the normal portable telephone line, because the lines in the base station 3 become congested or the like. In the present embodiment, the terminal 2 can reliably receive alarm information ALM from the base station 3 via the broadcast.

Furthermore, the terminal 2 can specify its own location when a GPS terminal function is built into the terminal 2. When the terminal 2 does not have a built in GPS terminal function, the terminal 2 can specify its own location based on position information from the base station 3. In this case, the terminal 2 may also be provided with a variable directional antenna.

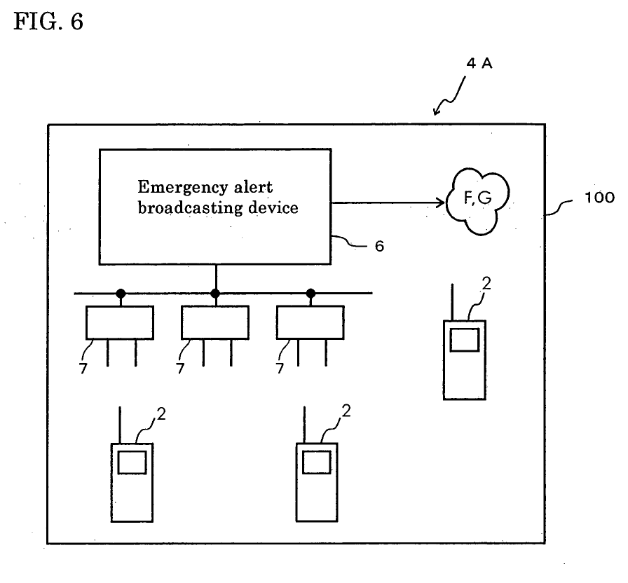

FIG. 6 is a schematic diagram showing an example of an emergency broadcasting system 4A that includes an emergency alert broadcasting device 6 according to one embodiment of the present invention. The emergency broadcasting system 4A includes the broadcasting device 6, a plurality of the portable communication terminals 2 and a plurality of the base stations 7. The broadcasting device 6 is configured and arranged to detect smoke F or noxious gas G such as toxic gas, explosive gas or the like in a target area 100, and broadcasts this information to the terminals 2 (portable telephones in the present embodiment) via a communication network. The target area 100 may be an interior of a facility such as an airport or the like, or may be outdoors. The toxic gas may be, for example, carbon monoxide, NOₓ, vesicant (mustard, lewisite), neurological agent (sarin, VX). The explosive gas may be, for example, a volatile gas that leaks from plastic bombs and the like. The communication network may be a public communication network or a dedicated line.

The terminal 2 may also be a special portable telephone that is held by a designated person such as the facility employees so that the designated person can guide people by following the information displayed in the terminal 2. The terminal 2 may also have a built in GPS terminal function, and may be provided with an ad hoc wireless function. Furthermore, a function for specifying its own position based on position information from the base station 7 may also be provided.

In the present embodiment, the terminal 2 is used to display information on the display section 24 to give the alarm information ALM described later and guide the user of the terminal 2 to the safe area SRG in emergency situation such as smoke or noxious gas event. Therefore, the terminal 2 is configured and arranged to receive information broadcasted from a wireless LAN base station installed by a security company or the like in an airport or the like, in addition to information broadcasted from the portable telephone base station.

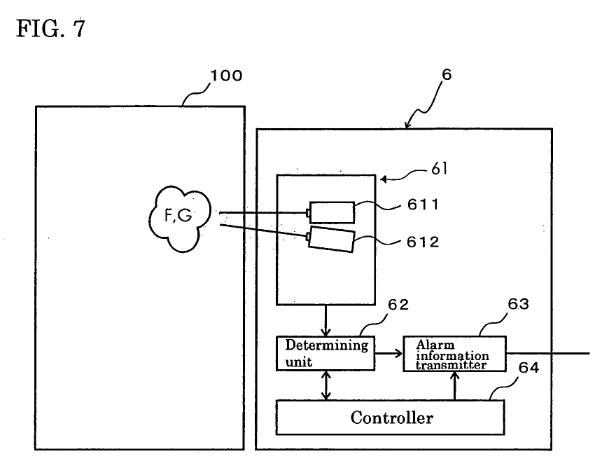

FIG. 7 is a schematic diagram of the broadcasting device 6 according to the one embodiment of the present invention. The broadcasting device 6 includes a plurality of detecting devices or sensors 61 (only one shown), a determining unit 62 (spectrum analyzer), an alarm information transmitter 63 (information sending unit), and a controller 64.

Each of the sensors 61 is provided with a laser emitter 611 (laser light emitting device) and a laser detector 612 (laser light detecting device). The laser emitter 611 is configured and arranged to emit a scanning laser beam in the target area 100. In the broadcasting device 6, the laser emitter 611 is configured and arranged to scan the target area 100 with two-dimensional scans (planar angle scan) or three-dimensional scans (solid angle scan) using a laser beam that has a plurality of frequency peaks (for example, optical frequency comb light or super continuum light). Optical frequency comb light or super continuum light having a wavelength of 500˜3000 nm may be used.

The laser light can be output in a state containing a plurality of frequency peaks, and can be output with frequency sweeps (changing the output frequency in a saw-tooth format). The laser detector 612 is capable of detecting laser light response (scattered, absorbed and the like), and can be arranged as, for example, a frequency filter and photodiode. Furthermore, a telescope can be used as the laser detector 612, in which case the laser detector 612 constitutes a laser radar together with the laser emitter 611.

By using a broadband and light source that emits optical frequency comb light or super continuum light, the type of noxious gas such as toxic gas, explosive gas or the like can be identified and suitable emergency measures can be included in the alarm information ALM. Furthermore, accurate fire detection, and precise detection of highly noxious gases are possible, thereby greatly reducing the possibility of erroneous information. Moreover, an optimum safe area and escape route guidance to the safe area can be displayed on the display 24 by detecting the direction of flow or the direction of dissemination of the smoke or noxious gas.

The determining unit 62 is configured and arranged to store standard criteria information which is compared to the detection response for determining the presence of smoke and noxious gas generated in the target area 100 by a terrorist chemical agent, bomb, or explosion. When a peak corresponding to stored frequency peak is detected, a signal specifying the information is sent to the alarm information transmitter 63.

The alarm information transmitter 63 is configured and arranged to transmit the alarm information ALM to the base stations 7 which includes the noxious gas location information and the evacuation route information ECP when the detection response information coincide with the standard criteria information. Although the noxious gas location information may be textual information, this information is preferably included in the map information MAP in the present embodiment. The controller 64 includes a CPU, ROM, and RAM, and is configured to control the entire system. The functions of the alarm information transmitter 63 are implemented by software executed by the controller 64.

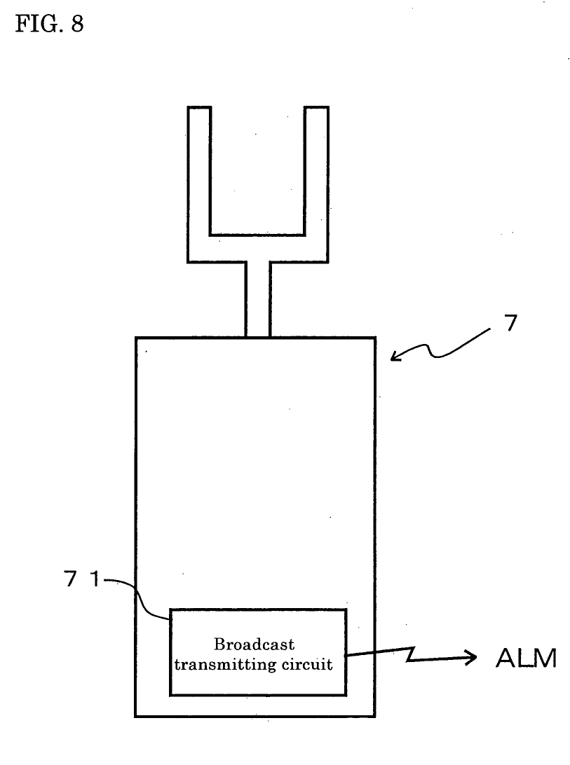

FIG. 8 is a schematic diagram of the base station 7. The base station 7 includes a broadcast transmitting circuit 71. The broadcast transmitting circuit 71 is configured and arranged to receive the alarm information ALM, which includes the map information MAP containing safe areas and the evacuation route information ECP to the safe areas (the evacuation route information EPC may be direction information), from the alarm information transmitter 63, and to transmit the alarm information ALM to the terminal 2. The base station 7 is configured and arranged to send an automatic activation request signal ASR to each terminal 2 prior to the broadcast transmission, and the terminal 2 is automatically activated when it receives the automatic activation request signal ASR, whereupon it receives the broadcast of the alarm information ALM.

The alarm information ALM may include information regarding first-aid treatment methods for people inhaled the noxious gas. In such case, the information on the first-aid treatment methods included in the alarm information ALM corresponds to the type of gas analyzed by the determining unit 62. The alarm information transmitter 63 may transmit the alarm information ALM with different content from the base stations 7 near the origin of the noxious gas and the base stations 7 that are remote from the origin of the noxious gas. For example, urgent prescriptions may be appended to the alarm information ALM transmitted by the base stations 7 near the origin of the noxious gas, whereas less hazardous instructions may be transmitted from the base stations 7 remote from the origin of the noxious gas.

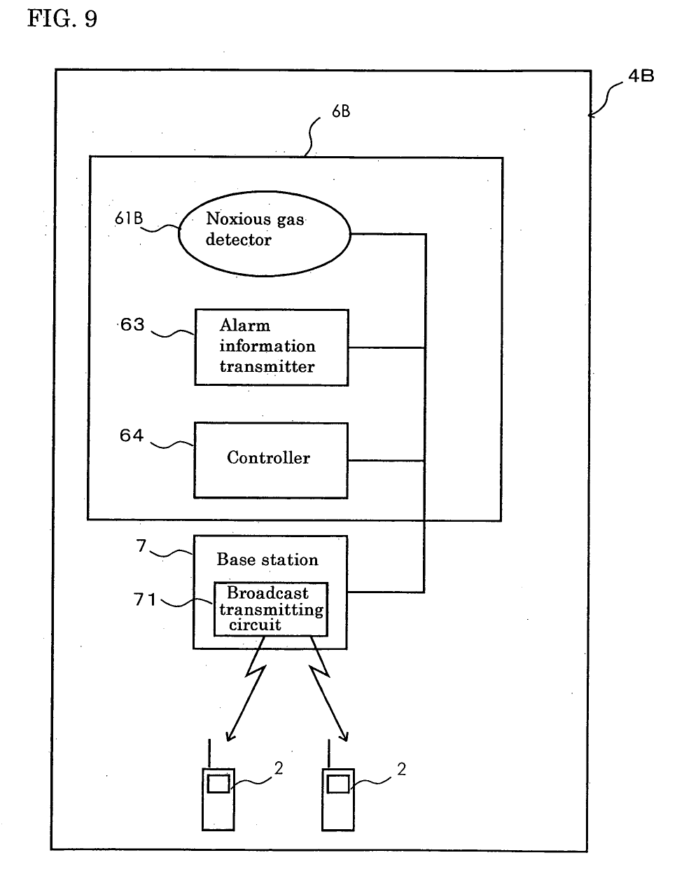

FIG. 9 is a schematic diagram of an example of an emergency broadcasting system 4B including an emergency alert broadcasting device 6B according to an alternative embodiment of the present invention. The broadcasting device 6B is configured to detect fire and smoke F or noxious gas G and to transmit the detection information to a plurality of the portable communication terminals 2, similar to the broadcasting device 6. The emergency broadcasting system 4B has the broadcasting device 6B, the terminals 2, and the base stations 7 (only one shown).

The broadcasting device 6B includes a noxious gas detector 61B, the alarm information transmitter 63, and the controller 64. The noxious gas detector 61B is a non-scanning type that employs, for example, gas chromatography, mass spectrography or the like. The noxious gas detector 61B is configured and arranged to detect a plurality of types of noxious gases (or specific types of noxious gases).

Although not mentioned above, the terminal 2 may be configured and arranged to output audio from a speaker in conjunction with the image displayed on the display section 24. Moreover, although the system has been described in terms of broadcast transmission and reception, the base station may be connected to the portable communication terminals via separate lines when the base station can accommodate many lines.

While the invention has been described in conjunction with what is presently considered to be the most practical and preferred embodiments, the invention is not limited to the disclosed embodiments, but on the contrary, is intended to cover various modifications and equivalent arrangements included within the spirit and scope of the appended claims.

What is claimed is:

1. A portable communication terminal comprising:
a receiving section configured and arranged to receive emergency information; and
a display section configured and arranged to display the emergency information.

2. The portable communication terminal of claim 1, wherein
the receiving section includes a broadcast receiving circuit.

3. The portable communication terminal of claim 1, further comprising
an azimuth measuring unit, and
a display circuit configured and arranged, based on at least one of map information and evacuation route information contained in the emergency information, to display at least one of a map and a evacuation route in the display section in a manner corresponding to an actual azimuth measured by the azimuth measuring unit.

4. The portable communication terminal of claim 1, further comprising,
a GPS terminal.

5. An evacuation route display system comprising:
a base station including a memory configured and arranged to store at least one of map information including safe area information and evacuation route information including evacuation routes to a safe area, and a broadcast transmitting circuit configured and arranged to transmit at least one of the map information and the evacuation route information to the portable communication terminal of claim 1 during emergency.

6. The evacuation route display system of claim 5, wherein
the base station is configured and arranged to transmit an automatic activation request signal to the portable communication terminal prior to transmitting the at least one of the map information and the evacuation route information.

7. An emergency alert broadcasting device comprising:
a detecting device configured and arranged to detect smoke or noxious gas generated in a target area and to output a detection value; and
an information sending unit configured and arranged to send at least one of evacuation information and origin location information of the smoke or the noxious gas detected by the detecting device over a communication network to a plurality of portable communication terminals when the detecting device detected the smoke or the noxious gas.

8. The emergency alert broadcasting device of claim 7, wherein
the detecting device includes a laser light emitting device configured and arranged to emit a laser light into the target area, and to scan the target area and a laser light detecting device configured and arranged to detect the laser light reflected or scattered in the target area or the laser light that has passed through the target area.

9. The emergency alert broadcasting device of claim 8, wherein
the laser light emitting device is configured and arranged to emit a broadband coherent laser beam, and the laser light detecting device is configured and arranged to detect a response to the broadband coherent laser beam at a plurality of frequencies.

10. The emergency alert broadcasting device of claim 7, wherein
the detecting device further includes a determining unit configured and arranged to determine a presence of the smoke or the noxious gas by comparing the detection value with a standard criteria information which is stored in the determination unit.

11. The emergency alert broadcasting device of claim 7, wherein
the evacuation information includes at least one of map information having safe area information and evacuation route information having evacuation routes to a safe area, and the origin location information includes map information of an origin of the smoke or the noxious gas.

12. The emergency alert broadcasting device of claim 7, wherein
the evacuation information includes a description of a first-aid treatment to perform when the noxious gas has been inhaled.
